(19) United States
(12) Patent Application Publication
(10) Pub. No.: US 2013/0214851 A1
(43) Pub. Date: Aug. 22, 2013

(54) VOLTAGE PUMP USING HIGH-PERFORMANCE, THIN-OXIDE DEVICES AND METHODS OF USE

(71) Applicant: John A. FIFIELD, Underhill, VT (US)

(72) Inventor: John A. FIFIELD, Underhill, VT (US)

(73) Assignee: INTERNATIONAL BUSINESS MACHINES CORPORATION, Armonk, NY (US)

(21) Appl. No.: 13/397,983

(22) Filed: Feb. 16, 2012

(51) Int. Cl. G05F 3/02

(52) U.S. Cl. 327/536

(57) ABSTRACT

A voltage pump using high-performance, thin-oxide devices and methods of use are provided. A multi-stage voltage boosting circuit includes a first boost capacitor with a first boosted voltage. The multi-stage voltage boosting circuit further includes a second boost capacitor with a second boosted voltage. The multi-stage voltage boosting circuit further includes a precharge transistor operable to precharge the first boost capacitor to a supply voltage. The multi-stage voltage boosting circuit further includes a precharge circuit operable to limit a stress voltage on the precharge transistor to the supply voltage, to drive the first boosted voltage to a gate of the precharge transistor in a boosting state, and to drive ground to the gate in a precharge state.

### FIELD OF THE INVENTION

The invention relates to voltage pump systems and, more particularly, to a voltage pump using high-performance, thin-oxide devices and methods of use.

### BACKGROUND

Voltage multiplier (pump or boost) circuits use a supply voltage as an input, and generate a multiplied power supply level. For example, a voltage tripler with a supply voltage (VDD) of 1 volt (V), can generate an output voltage of 3 V. Voltage multiplier circuits may be used in flash memory, embedded dynamic random access memory (eDRAM), and other integrated circuits, to provide a voltage greater than a supply voltage. This multiplied level may be used, e.g., to provide adequate overdrive on DRAM memory word lines, to provide a power supply for a diode-based bandgap reference circuit, amongst other uses. Typical power supply levels may be about 1 V or less, and required multiplied levels may be regulated to about 2 V regardless of input power supplies.

Integrated circuit technology can typically include thick-oxide, high-voltage, low-performance, field-effect transistor (FET) devices with gate oxide (e.g., silicon dioxide) thicknesses of about 24-52 Ångstroms (Å). The thick gate oxide is used to prevent gate oxide voltage breakdown. However, transconductance or performance of these thick-oxide FET devices is inversely proportional to their gate oxide thicknesses. Accordingly, a thick-oxide FET device capable of safe operation in a high voltage of, e.g., 2 V, has a lower performance than a thinner-oxide FET of a similar size.

In addition, these low-performance FET devices have poor density and have threshold voltages (Vt) as high as 500 mV, which limits low-voltage operability. For example, eDRAM macros need to operate well below a power supply voltage of 1 V, and to safely operate up to a power supply voltage of 1.1 V. Accordingly, existing voltage multiplier circuits must be designed with thick-oxide, high-voltage FET devices to tolerate the power supply voltage of 1.1 V. However, these high-voltage FET devices perform poorly at a power supply voltage of 0.65 V.

Accordingly, there exists a need in the art to overcome the deficiencies and limitations described hereinabove.

### SUMMARY

In a first aspect of the invention, a multi-stage voltage boosting circuit includes a first boost capacitor with a first boosted voltage. The multi-stage voltage boosting circuit further includes a second boost capacitor with a second boosted voltage. The multi-stage voltage boosting circuit further includes a precharge transistor operable to precharge the first boost capacitor to a supply voltage. The multi-stage voltage boosting circuit further includes a precharge circuit operable to limit a stress voltage on the precharge transistor to the supply voltage, to drive the first boosted voltage to a gate of the precharge transistor in a boosting state, and to drive ground to the gate in a precharge state.

In another aspect of the invention, a voltage boosting circuit for tripling a supply voltage, includes a first boost capacitor with a first boosted voltage. The voltage boosting circuit further includes a second boost capacitor with a second boosted voltage. The voltage boosting circuit further includes a precharge transistor operable to precharge the first boost capacitor to the supply voltage. The voltage boosting circuit further includes a precharge circuit operable to limit a stress voltage on the precharge transistor to the supply voltage.

In yet another aspect of the invention, a method includes precharging a boost capacitor to a supply voltage. The method further includes limiting a stress voltage on a precharge transistor to the supply voltage. The method further includes boosting the supply voltage to a boosted voltage.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 is a schematic diagram of a voltage pump using high-performance, thin-oxide devices in accordance with aspects of the invention;

FIG. 2 is a waveform plot of voltages in the voltage pump in accordance with aspects of the invention;

FIG. 3 is an output current-voltage plot of the voltage pump in accordance with aspects of the invention, and of a known voltage pump; and

FIG. 4 is waveform plot of a voltage at a thin-oxide device in the voltage pump in accordance with aspects of the invention, and of a voltage at a thick-oxide device in the known voltage pump.

### DETAILED DESCRIPTION

The invention relates to voltage pump systems and, more particularly, to a voltage pump using high-performance, thin-oxide devices and methods of use. More specifically, in embodiments, the present invention includes a voltage pump which can generate a boosted supply voltage using thin-oxide, low-voltage, high-performance field-effect transistor (FET) devices, instead of those with thick oxide. For example, each of these FET devices may have a gate oxide thickness of about 11-15 Ångstroms (Å) although other thicknesses and ranges are contemplated by the invention.

In embodiments, the voltage pump can be a two-stage voltage-boosting device which includes first and second boost capacitors, each having a precharge circuit. For example, the first boost capacitor may be precharged by its precharge circuit which uses an output voltage of the first boost capacitor and a supply voltage (VDD) precharge signal. Using this technique, differential voltages across a first precharge FET may be no greater than VDD, which allows the first precharge FET to be a thin-oxide, low-voltage, high-performance FET.

Advantageously, using thin-oxide, low-voltage, high-performance FETs, density can be improved in the voltage pump, and current output (e.g., performance) of the voltage pump can increase, since the precharge circuits do not use a boosted supply voltage. Instead, the precharge circuits use a VDD-level signal which lowers a load on the boosted supply voltage. In addition, boosted-level selection signals for a variable charge control in the voltage pump may be eliminated, saving additional boosted charge and eliminating the need for level translator circuits, thereby further improving density. Further, the thin-oxide, low-voltage, high-performance FETs improve the low-voltage operability of the voltage pump since their voltage thresholds may be about 250 millivolts (mV) or less. Accordingly, a supply voltage in a range between, e.g., about 0.65 V to 1.1 V may be implemented with the present invention. One of ordinary skill in the art would recognize that these voltages and ranges are exemplary and that other voltages and ranges are contemplated by the invention.

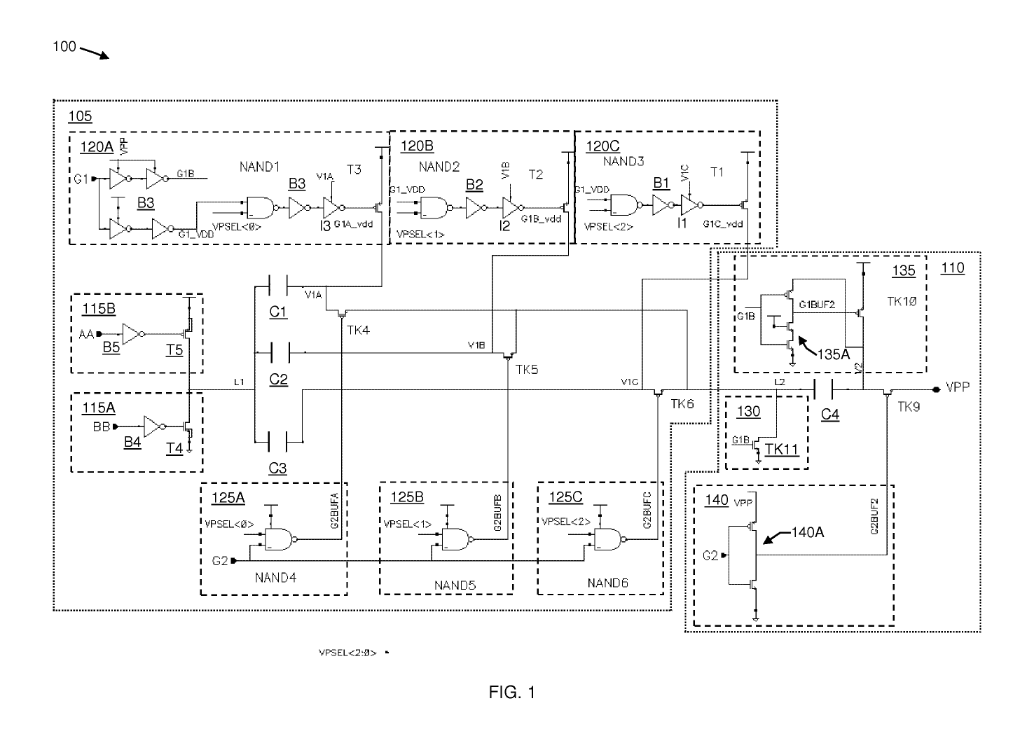

FIG. 1 is a schematic diagram of a voltage pump 100 using high-performance, thin-oxide devices in accordance with aspects of the invention. In embodiments, the voltage pump 100 can be used in an integrated circuit (IC) designed to substantially operate at a supply voltage VDD, and which requires a boosted voltage VPP relative to the supply voltage VDD. The voltage pump 100 includes a two-stage voltage pump circuit (e.g., a first stage 105 and a second stage 110) which may generate the boosted voltage VPP to be, e.g., about 3 times the supply voltage VDD in value, although other voltage values are contemplated by the invention. For example, the voltage pump 100 may generate the boosted voltage VPP to be, e.g., about 2.9 volts (V) for the supply voltage VDD of about 1.1 V.

As should be understood by reviewing FIG. 1, and in contrast to conventional voltage pumps, in embodiments, the voltage pump 100 can include thin-oxide, low-voltage, and high-performance field-effect transistors (FETs) T3, T2, and T1. Each of the FETs T3, T2, and T1 may withstand a gate oxide stress voltage equal to the supply voltage VDD, e.g., about 1.1 V. Advantageously, using the thin-oxide, low-voltage, high-performance FETs T3, T2, and T1, density can be improved in the voltage pump 100, and current output and speed (e.g., performance) of the voltage pump 100 can increase. Further, the thin-oxide, low-voltage, high-performance FETs T3, T2, and T1 may improve low-voltage-operability of the voltage pump 100 since their voltage thresholds may be less.

In order to use the thin-oxide, low-voltage, and high-performance FETs T3, T2, and T1, instead of thick-oxide, high-voltage, and low-performance FETs, the voltage pump 100 can adjust gate voltages at the FETs T3, T2, and T1. More specifically, in embodiments, in a precharge phase of the voltage pump 100, voltage boost capacitors C1, C2, and C3 may be precharged using the FETs T3, T2, and T1, respectively, with their gate voltages at ground, e.g., about 0 V. In a boost phase, the FETs T3, T2, and T1 may be turned off by switching their gate voltages to an increased voltage, e.g., 2VDD or about 2 V, as described herein.

More specifically, referring to FIG. 1, the voltage pump 100 can include a first stage 105 and a second stage 110. The first stage 105 may include voltage boost capacitors C1, C2, and C3, a restore circuit 115A, a boost circuit 115B, precharge circuits 120A, 120B, and 120C, the output passgates TK4, TK5, and TK6, and gate control circuits 125A, 125B, and 125C. The second stage 110 may include a voltage boost capacitor C4, a restore circuit 130, a precharge circuit 135, and output passgates TK9, and the gate control circuit 140.

More specifically, in embodiments, the first stage 105 may include the voltage boost capacitors C1, C2, and C3 which have a low node L1 and high nodes V1A, V1B, and V1C, respectively. The restore circuit 115A may connect the low node L1 to ground, while the boost circuit 115B may connect the low node L1 to the supply voltage VDD. The restore circuit 115A and the boost circuit 115B may include inverter buffers B4 and B5 and thin-oxide, low-voltage, and high-performance FETs T4 and T5, respectively, since only a gate oxide stress voltage of VDD (e.g., about 1.1 V) may be applied thereto.

In accordance with further aspects of the invention, the first stage 105 can further include the precharge circuits 120A, 120B, and 120C connected to the high nodes V1A, V1B, and V1C, respectively. The precharge circuits 120A, 120B, and 120C may include inverter buffers B3, B2, and B1, NAND gates NAND1, NAND2, and NAND3, inverters I3, I2, and I1, and the thin-oxide FETs T3, T2, and T1, respectively. Each of these FETs T3, T2, and T1 may include a gate oxide thickness of about 11-15 Ångstroms (Å), although other thicknesses and ranges are contemplated by the invention. That is, each gate oxide of the FETs T3, T2, and T1 may be about ⅖ a thickness of a gate oxide of a thick-oxide FET used in conventional voltage pumps that is about 24-52 Ångstroms (Å). In addition, each gate oxide of the FETs T3, T2, and T1 may be about ⅖ a thickness of each gate oxide of output passgates TK4, TK5, and TK6, respectively. Each of the FETs T3, T2, and T1 may withstand a gate oxide stress voltage equal to the supply voltage VDD, e.g., about 1.1 V. One of ordinary skill in the art would recognize that these gate oxide thickness ratios and gate oxide stress voltages are exemplary and other gate oxide thickness ratios and gate oxide stress voltages are contemplated by the invention.

In embodiments, the output passgates TK4, TK5, and TK6 (e.g., thick-oxide FETs for voltage boosting) can also be connected to the high nodes V1A, V1B, and V1C, respectively. The gate control circuits 125A, 125B, and 125C may be connected to the output passgates TK4, TK5, and TK6, respectively. The gate control circuits 125A, 125B, and 125C may include NAND gates NAND4, NAND5, and NAND6, respectively. Each of the gate control circuits 125A, 125B, and 125C may provide a gate voltage to turn on or off the output passgates TK4, TK5, and TK6, respectively. The gate voltage may include a change in voltage no greater than the supply voltage VDD.

In accordance with further aspects of the invention, the second stage 110 can include the voltage boost capacitor C4 which has a low node L2 and a high node V2. The restore circuit 130 may connect the low node L2 to ground, and may include a thick-oxide FET TK11 since a gate oxide stress voltage of 2VDD (e.g., about 2 V) may be applied. The precharge circuit 135 may be connected to the high node V2, and may include FETs 135A and a thick-oxide FET TK10 since a gate oxide stress voltage of 2VDD (e.g., about 2 V) may be applied. The output passgates TK9 (e.g., a thick-oxide FET for voltage boosting) may also be connected to the high node V2. A gate control circuit 140 may be connected to the output passgate TK9, and may include FETs 140A. The gate control circuit 140 may provide a gate voltage to turn on or off the output passgate TK9.

In embodiments, the voltage pump 100 can receive input timing signals AA, BB, G1, G2, and VPSEL<2:0> in order to control phases or stages of the voltage pump 100. The input timing signals AA, BB, and VPSEL<2:0> may include a low voltage level of ground (e.g., about 0 V) and a high voltage level of the supply voltage VDD (e.g., about 1.1 V). That is, the input timing signals AA, BB and VPSEL<2:0> may include non-boosted logic voltage levels of 0 V and VDD. The boosted level input timing signals G1 and G2 may be lightly-loaded, as they connect to small inverters and logic gates, and are not connected to the precharge FETs T3, T2, and T1. Advantageously, by using the non-boosted input timing (select) signals VPSEL<2:0>, the voltage pump 100 does not require level translators to adjust the variable charge level to the boosted voltage VPP. In addition, by restricting the use of the boosted voltage VPP to the lightly-loaded input timing signals G1 and G2, the voltage pump 100 consumes less of its output current and thereby increases circuit efficiency.

For example, in embodiments, in a precharge phase, the input timing signal BB can drive the restore circuit 115A to restore the low node L1 to ground, e.g., about 0 V. At a same time, the input timing signals G1 and VPSEL <2:0> may drive one or more of the precharge circuits 120A, 120B, and 120C to charge the high nodes V1A, V1B, and V1C, respectively, to the supply voltage VDD. That is, the precharge circuits 120A, 120B, and 120C precharge the capacitors C1, C2, and C3, respectively, to the supply voltage VDD. Further, in the precharge phase, the input timing signals G2 and VPSEL<2:0> may drive the gate control circuits 125A, 125B, and 125C to hold each of the output passgates TK4, TK5, and TK6, respectively, in an off state at the supply voltage VDD. The VPSEL<2:0> may be used to select which of the capacitors C1, C2, and/or C3 and the output passgates TK4, TK5, and/or TK6, respectively, are subsequently used to adjust the variable charge level at the output node VPP. For example, the capacitors C1, C2, and/or C3 may be selected to adjust charge based on anticipated load requests on the voltage pump 100. More specifically, in embodiments, when a high load is required, all of the capacitors C1, C2, and C3 may be selected (via the VPSEL<2:0>) to assure that the high load is satisfied. When a low load is required, only one of the capacitors C1, C2, and C3 may be selected to avoid over-boosting the supply voltage VDD.

In embodiments, at the same time, the input timing signal G1 (e.g., a buffered and boosted version G1B of the input timing signal G1) may drive the restore circuit 130 to restore the low node L2 to ground, and may drive the precharge circuit 135 to charge the high node V2 to the supply voltage VDD. In the precharge phase, the input timing signal G2 may drive the gate control circuit 140 to hold the output passgate TK9 in an off state at a stress limit voltage, e.g., the boosted voltage VPP.

More specifically, in embodiments, the precharge circuits 120A, 120B, and 120C can include the thin-oxide, low-voltage, high-performance FETs T3, T2, and T1, respectively. In embodiments, each of the FETs T3, T2, and T1 may include a gate oxide thickness of, e.g., about 11-15 Ångstroms (Å), although other gate oxide thicknesses and dimensions are contemplated by the invention. Each of the FETs T3, T2, and T1 may include an on-gate voltage of ground (e.g., about 0 V), and an off-gate voltage set by a high voltage level of the respective high nodes V1A, V1B, and V1C (e.g., 2VDD or about 2 V). Each of the FETs T3, T2, and T1 may be controlled by the input timing signals VPSEL<2:0>, respectively, and a restore phase (e.g., precharge signal) G1_VDD which may include a low voltage level of ground and a high voltage level of the supply voltage VDD, e.g., about 1.1 V.

In embodiments, in the precharge phase or an on state, each of the inverters I3, I2, and I1 can receive the restore phases G1A_vdd, G1B_vdd, and G1C_vdd, respectively, at a ground voltage level, e.g., about 0 V. Using this low voltage level, each of the inverters I3, I2, and I1 drive a gate of each of the respective FETs T3, T2, and T1 (at respective nodes G1A_vdd, G1B_vdd, and G1C_vdd) in response to the VDD voltage level of the restore phase G1_VDD. A source of each of the FETs T3, T2, and T1 may be at the supply voltage VDD, e.g., about 1.1 V. A resulting gate-to-source voltage (Vgs) of each of the FETs T3, T2, and T1 may be −VDD or about −1.1 V.

In accordance with further aspects of the invention, a drain of each of the FETs T3, T2, and T1 can be charged to 2VDD or about 2 V during the boost phase, but may be discharged to less than VDD or less than about 1.1 V when the voltage pump 100 cycles from its boost phase to its precharge phase by activation of the restore circuit 115A. As the low node L1 is pulled to ground by the restore circuit 115A, each of the high nodes V1A, V1B, and V1C are pulled down below VDD, before the restore phase G1_VDD is activated. Accordingly, a gate-to-drain voltage (Vgd) of each of the FETs T3, T2, and T1 may be limited to −VDD or about −1.1 V. A drain-to-source voltage (Vds) may include a maximum value of about ½. Advantageously, in the precharge phase, there is never more than VDD or about 1.1 V of a gate oxide stress voltage on each of the FETs T3, T2, and T1, which allows these FETs T3, T2, and T1 to be fabricated with thin-oxide.

In embodiments, in a subsequent boost or transfer phase, the input timing signal AA can drive the boost circuit 115B to drive the low node L1 to the supply voltage VDD, e.g., about 1.1 V. This increases the voltage at one or more of the high nodes V1A, V1B, and V1C (of the capacitors C1, C2, and C3, respectively) to about twice the supply voltage VDD, e.g., 2VDD. At a same time, the input timing signals G2 and VPSEL<2:0> may drive the gate control circuits 125A, 125B, and 125C to hold one or more of the output passgates TK4, TK5, and TK6, respectively, in an on state at a low voltage level (e.g., about 0 V) such that a stress limit voltage of the output passgates TK4, TK5, and TK6 is not exceeded. With one or more of the output passgates TK4, TK5, and TK6 in the on state, the increased voltages at one or more of the high nodes V1A, V1B, and V1C may be transferred to the low node L2, which may increase the voltage at the high node V2 to, e.g., about 3VDD (or more preferably, the boosted voltage VPP of about 2.9 V). In embodiments, the select signals VPSEL<2:0> may be direct current (DC) signals which are held in a state to utilize all or a portion of a charge available from the first-stage capacitors C3, C2 and C1, respectively. A charge level of the boosted voltage VPP may be adjusted to match a load requirement by adjustment of the select signals VPSEL<2:0>.

In accordance with further aspects of the invention, in the boost phase, the input timing signal G2 can drive the gate control circuit 140 to hold the output passgate TK9 in an on state at a low voltage level (e.g., about 0 V). In this way, the increased voltage at the high node V2 is transferred to the output node VPP, e.g., as the boost voltage VPP. During the boost phase, the input timing signal G1 (e.g., the buffered and boosted version G1B of the input timing signal G1) can turn off the precharge circuit 135 to prevent output charge from bleeding back through to the supply voltage VDD of the precharge circuit 135.

More specifically, in embodiments, in the boost phase or an off state, each of the inverters I3, I2, and I1 can receive the restore phase G1_VDD at its low state (e.g., about 0 V), and the respective increased voltages at the high nodes V1A, V1B, and V1C that are at their high voltage level of, e.g., 2VDD or about 2 V. Using this high voltage level, the inverters I3, I2, and I1 drive the gate of each of the respective FETs T3, T2, and T1 (at the respective nodes G1A_vdd, G1B_vdd, and G1C_vdd) to the high voltage level of the respective high nodes V1A, V1B, and V1C. This may be accomplished by setting to ground the restore phase G1_VDD after the respective capacitors C1, C2, and C3 are precharged. That is, each of the precharge circuits 120A, 120B, and 120C may use respective output voltages of the capacitors C1, C2, and C3 (e.g., the respective increased voltages at the high nodes V1A, V1B, and V1C) to turn off the FETs T3, T2, and T1, respectively. The resulting gate-to-source voltage (Vgs) of each of the FETs T3, T2, and T1 may be VDD or about 1.1 V.

In accordance with further aspects of the invention, the drain of each of the FETs T3, T2, and T1 can be charged to 2VDD or about 2 V during the boost phase. Accordingly, the gate-to-drain voltage (Vgd) of each of the FETs T3, T2, and T1 may be limited to about 0 V. The drain-to-source voltage (Vds) may include a maximum value of −VDD or about −1.1 V. Advantageously, in the boost phase, there is never more than VDD or about 1.1 V of a gate oxide stress voltage on each of the FETs T3, T2, and T1, which allows these FETs T3, T2, and T1 to include thin-oxide.

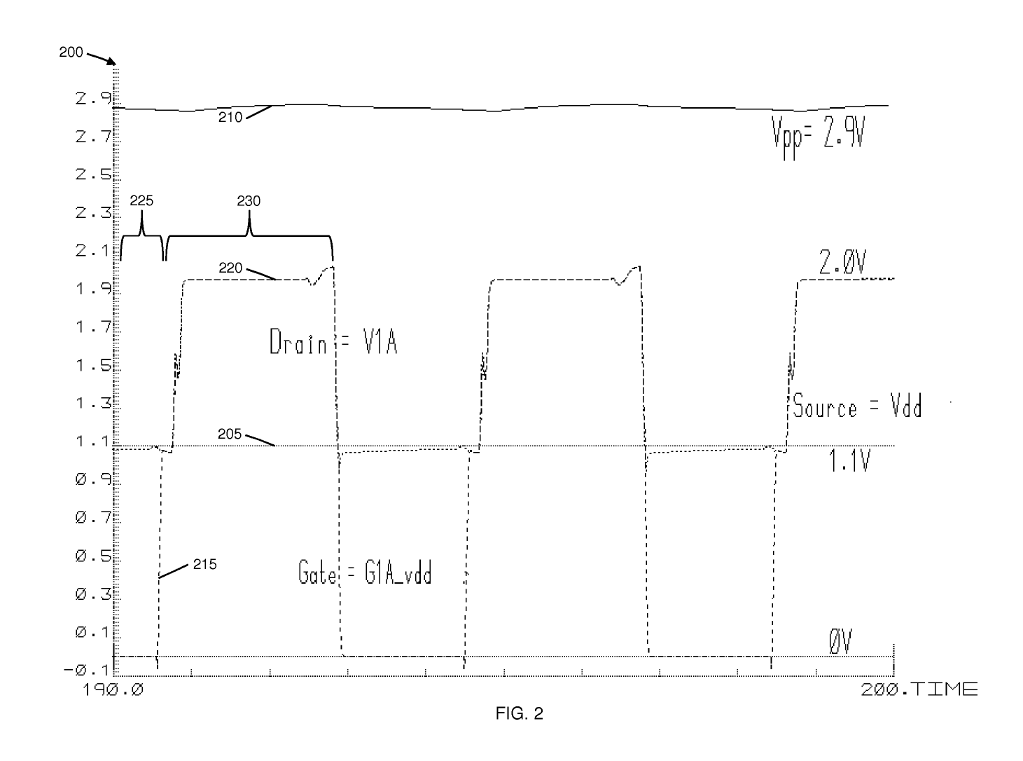

FIG. 2 is a waveform plot 200 of voltages over time in the voltage pump 100 in FIG. 1 in accordance with aspects of the invention. In embodiments, the waveform plot 200 can include an x-axis of time and a y-axis of voltage, in the voltage pump 100. The waveform plot may further include a supply voltage VDD 205 (e.g., a source voltage of the FET T3 in FIG. 1) of about 1.1 V, and a boosted voltage VPP 210 of about 2.9 V. The waveform plot 200 may further include a gate voltage 215 of the FET T3 (at the node G1A_vdd), and a drain voltage 220 of the FET T3 (at the high node V1A).

In embodiments, in a precharge phase 225, the gate voltage 215 of the FET T3 can be driven to a low voltage level of ground, e.g., about 0 V. A resulting gate-to-source voltage (Vgs) of the FET T3 may be −VDD or about −1.1 V. The drain voltage 220 of the FET T3 may be discharged to less than VDD or less than about 1.1 V. Accordingly, a gate-to-drain voltage (Vgd) of the FET T3 may be limited to −VDD or about −1.1 V. Advantageously, in the precharge phase 225, there is never more than VDD or about 1.1 V of a gate oxide stress voltage on the FET T3, which allows the FET T3 to be fabricated with thin-oxide.

In accordance with further aspects of the invention, in a boost phase 230, the gate voltage 215 of the FET T3 can be driven to a high voltage level of the high node V1A, e.g., 2VDD or about 2 V. The resulting gate-to-source voltage (Vgs) of the FET T3 may be VDD or about 1.1 V. The drain voltage 220 of the FET T3 may also be charged to 2VDD or about 2 V during the boost phase. Accordingly, the gate-to-drain voltage (Vgd) of the FET T3 may be limited to about 0 V. The drain-to-source voltage (Vds) may include a maximum value of −VDD or about −1.1 V. Advantageously, in the boost phase, there is never more than VDD or about 1.1 V of a gate oxide stress voltage on the FET T3, which allows the FET T3 to be fabricated from thin-oxide. This may be accomplished by driving the gate voltage 215 with the high voltage level of a first-stage boosted node (e.g., the high node V1A), instead of with the triple boosted output voltage VPP as in the known art. In addition, the voltage pump 100 may eliminate waste from discharge from an excessively negative Vgs in cut off.

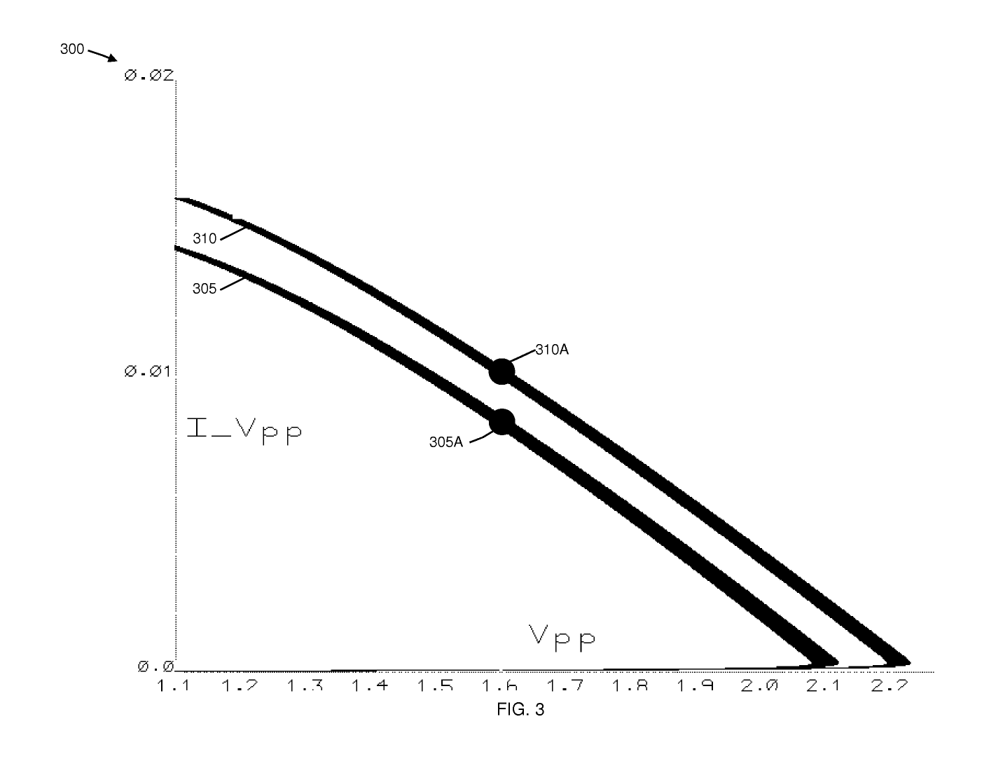

FIG. 3 is an output current-voltage plot 300 of the voltage pump 100 in FIG. 1 in accordance with aspects of the invention, and of a known voltage pump with thick-oxide devices and level translators. In embodiments, both the known voltage pump and the voltage pump 100 of the present invention can include twelve pumps in a four-phase, 300 megahertz (mHz) system. The output current-voltage plot 300 may include an output current-voltage curve 305 for the known voltage pump, and an output current-voltage curve 310 for the voltage pump 100 of the present invention. The output current-voltage curve 310 for the voltage pump 100 of the present invention shows improved (e.g., larger) current and efficiency over the output current-voltage curve 305 of the known voltage pump.

For example, the output current-voltage curve 310 includes an output current-voltage point 310A which shows an output current (I_Vpp) of about 10.2 milliamps (mA) per an output voltage (Vpp) of about 1.6 V. In contrast, the output current-voltage curve 305 includes an output current-voltage point 305A which shows an output current of about 8.5 mA per a same output voltage of about 1.6 V. Current capacity of the output voltage in the voltage pump 100 of the present invention is increased because precharge is more complete when using thin-oxide, high-performance devices. In addition, the voltage pump 100 of the present invention is more efficient since less of the output current is consumed by level translators and large, thick-oxide precharge devices.

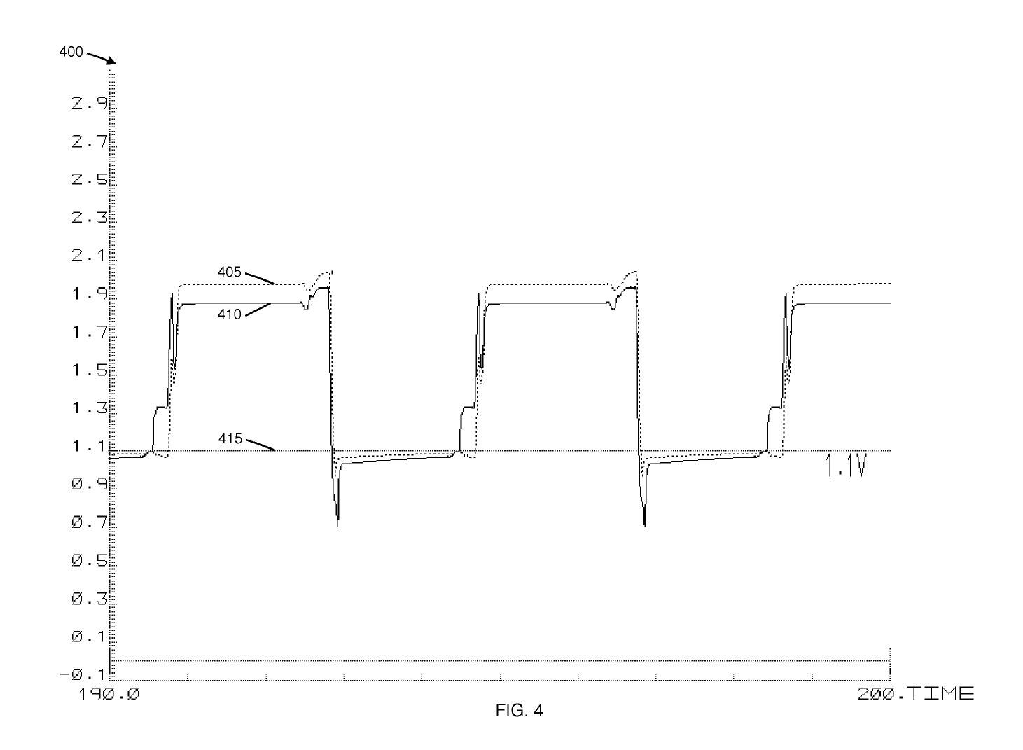

FIG. 4 is waveform plot 400 of a drain voltage 405 over time at a thin-oxide device (e.g., the FET T3 in FIG. 1) in the voltage pump 100 in accordance with aspects of the invention, and of a drain voltage 410 over time at a thick-oxide device in the known voltage pump. In embodiments, both the voltage pump 100 of the present invention and the known voltage pump can include a supply voltage 415 of VDD or about 1.1 V. The drain voltage 405 at the thin-oxide device in the voltage pump 100 of the present invention shows improved (e.g., larger) voltage levels over the drain voltage 410 at the thick-oxide device in the known voltage pump. This is because during a precharge phase, a gate of the thin-oxide device in the voltage pump 100 of the present invention uses a smaller amount of boosted charge from a first boost voltage level (e.g., the high node VIA in FIG. 1), instead of consuming charge from the output boost voltage level (e.g., 3VDD or about 2.9 V). That is, the improved precharge or restore phase of the voltage pump 100 using thin-oxide devices reduces charge consumption such that more charge is available to drive an output load.

The circuit as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A multi-stage voltage boosting circuit comprising:
a first boost capacitor with a first boosted voltage;
a second boost capacitor with a second boosted voltage;
a precharge transistor operable to precharge the first boost capacitor to a supply voltage; and
a precharge circuit operable to limit a stress voltage on the precharge transistor to the supply voltage, to drive the first boosted voltage to a gate of the precharge transistor in a boosting state, and to drive ground to the gate in a precharge state.

2. The multi-stage voltage boosting circuit of claim 1, wherein the precharge circuit drives the first boosted voltage to the gate of the precharge transistor in the boosting state to turn off the precharge transistor.

3. The multi-stage voltage boosting circuit of claim 1, wherein the precharge transistor is a thin-oxide transistor comprising a gate oxide voltage limit equal to the supply voltage.

4. The multi-stage voltage boosting circuit of claim 1, wherein the precharge circuit receives a selection input signal comprising a change in voltage no greater than the supply voltage.

5. The multi-stage voltage boosting circuit of claim 1, wherein the second boosted voltage is derived from the first boosted voltage.

6. The multi-stage voltage boosting circuit of claim 5, wherein the second boosted voltage is about 2.9 volts.

7. The multi-stage voltage boosting circuit of claim 1, wherein the precharge transistor comprises a gate oxide thickness in a range of about 11 Ångstroms to about 15 Ångstroms.

8. The multi-stage voltage boosting circuit of claim 1, wherein the supply voltage is in a range of about 0.65 volts to about 1.1 volts.

9. The multi-stage voltage boosting circuit of claim 1, wherein the first boosted voltage is about 2 volts.

10. The multi-stage voltage boosting circuit of claim 1, further comprising:
an output passgate transistor connected to the first boost capacitor; and
a gate control circuit connected to a gate of the output passgate transistor, the gate control circuit operable to provide a gate voltage to the gate of the output passgate transistor to turn on or off the output passgate transistor, and the gate voltage comprising a change of voltage no greater than the supply voltage.

11. A voltage boosting circuit for tripling a supply voltage, comprising:
a first boost capacitor with a first boosted voltage;
a second boost capacitor with a second boosted voltage;
a precharge transistor operable to precharge the first boost capacitor to the supply voltage; and
a precharge circuit operable to limit a stress voltage on the precharge transistor to the supply voltage.

12. The voltage boosting circuit of claim 11, wherein the precharge circuit drives the first boosted voltage to a gate of the precharge transistor in a boosting state, and drives ground to the gate in a precharge state.

13. The voltage boosting circuit of claim 11, wherein the precharge transistor is a thin-oxide transistor comprising a gate oxide voltage limit equal to the supply voltage.

14. The voltage boosting circuit of claim 11, wherein the precharge circuit receives a selection input signal comprising a change in voltage no greater than the supply voltage.

15. The voltage boosting circuit of claim 11, wherein the voltage boosting circuit outputs the second boosted voltage as a boosted output voltage.

16. The voltage boosting circuit of claim 11, wherein the second boosted voltage is derived from the first boosted voltage.

17. The voltage boosting circuit of claim 11, wherein the precharge transistor comprises a gate oxide thickness in a range of about 11 Ångstroms to about 15 Ångstroms.

18. The voltage boosting circuit of claim 11, further comprising:
an output passgate transistor connected to the first boost capacitor; and
a gate control circuit connected to a gate of the output passgate transistor, the gate control circuit operable to provide a gate voltage to the gate of the output passgate transistor to turn on or off the output passgate transistor, and the gate voltage comprising a change of voltage no greater than the supply voltage.

19. A method comprising:
precharging a boost capacitor to a supply voltage;
limiting a stress voltage on a precharge transistor to the supply voltage; and
boosting the supply voltage to a boosted voltage.

20. The method of claim 19, further comprising:
receiving a selection input signal comprising a change in voltage no greater than the supply voltage; driving the boosted voltage to a gate of the precharge transistor in a boosting state; and
driving ground to the gate in a precharge state.
